(19) United States
(12) Patent Application Publication
(10) Pub. No.: US 2014/0083389 A1
(43) Pub. Date: Mar. 27, 2014

(54) CYLINDER HEAD WITH ANNULAR VALVE FOR INTERNAL-COMBUSTION ENGINE

(71) Applicants: Vaclav Knob, Praha 6 (CZ); Ondrej Bolehovsky, Pisek (CZ)

(72) Inventors: Vaclav Knob, Praha 6 (CZ); Ondrej Bolehovsky, Pisek (CZ)

(21) Appl. No.: 14/115,247

(22) PCT Filed: May 3, 2012
(86) PCT No.: PCT/CZ2012/000037

§ 371 Date: Dec. 5, 2013

(30) Foreign Application Priority Data
May 3, 2011 (CZ) PV2011-259

(51) Int. Cl. F02F 1/24

(52) U.S. Cl. CPC F02F 1/24
USPC 123/193.3

(57) ABSTRACT

Cylinder head of combustion engine with ring-shaped valve comprising the body (1) and rigid centre (2) of cylinder head and ring-shaped valve (3) with outer seating face (21) and inner seating face (20), which in its closed position sits down into outer valve seat (5) with outer seating face (11) and inner valve seat (4) with inner seating face (10). Inner valve seat (4) and/or outer valve seat (5) is fitted slidably in axial direction and to inner valve seat (4) and/or to outer valve seat (5) is connected at least one pressure member (6) for causing force against ring-shaped valve (3).

### TECHNICAL FIELD

This invention relates to embodiment of a cylinder head of internal combustion engine equipped with lifting valve, the plate of which is in the shape of ring and which has sealing surface on its inner and outer circumference. The valve in closed position sits down by this inner and outer seating face onto inner and outer valve seat placed in cylinder head.

### BACKGROUND OF THE INVENTION

Many embodiment of cylinder head with ring-shaped valve or valves has been designed. Most of them deal with the principle of cylinder charge exchange with four-stroke or two-stroke cycle with use of ring-shaped valve. They don't deal with construction details of valve sealing usually. In some cases the sealing surfaces of inner and outer valve seat are placed on one plane or cone surface in order to be able to easily precisely machine these surfaces in one operation and ensure so tightness of the ring-shaped valve. These solutions are described e. g. in files U.S. Pat. No. 2,222,730, U.S. Pat. No. 2,222,731, DE 3438847 A1, U.S. Pat. No. 5,673,656. Tightness of ring-shaped valve in both valve seats is however problem not only from point of view of precise machining of valve seats and valves, but even problem of thermal and mechanical deformations. It could be deformation of cylinder head, both of valve seats and finally ring-shaped valve too. Further problem for tightness of ring-shaped valve is unequal wear of seating faces of outer and inner seat and valve. The question is the design of seats and cylinder head with respect to their installation into the cylinder head, adjustment and repairs.

### SUMMARY OF THE INVENTION

The above deficiencies are to a considerable extent removed by internal combustion engine with ring-shaped valve comprising body and rigid centre of the cylinder head and ring-shaped valve with outer seating face and inner seating face, which in its closed position sits down into outer valve seat with outer seating face and into inner valve seat with inner seating face according to this solution. Its substance is that the inner valve seat and/or outer valve seat is fitted slidably in axial direction and to inner valve seat and/or to outer valve seat is connected at least one pressure member for causing force against the ring-shaped valve.

Slideably movable inner valve seat and/or outer valve seat is provided with at least one sealing member, situated between inner valve seat and the centre of the combustion engine cylinder head and/or between outer valve seat and the body of the combustion engine cylinder head.

Sealing member is placed in a groove in the centre of the cylinder head of the combustion engine and/or in the cylinder head body of the combustion engine. Sealing member is formed by sealing ring on the slideably moveable inner valve seat, where contact diameter of sealing member with inner valve seat is larger than seating face diameter of this inner valve seat with ring-shaped valve.

Sealing member is formed by sealing ring on the slideably moveable outer valve seat, where contact diameter of sealing ring with outer valve seat is smaller than seating face diameter of this outer valve seat with ring-shaped valve.

Slideably moveable inner valve seat and/or outer valve seat is provided with safety element preventing its pulling towards the cylinder. Slideably moveable inner valve seat and/or outer valve seat is provided with at least two stems, leading through the centre and/or through the body of the cylinder head of the combustion engine, provided with adjustable stops and/or dampers on their ends.

Seating face of slideably moveable inner valve seat and/or outer valve seat is spherical.

Pressure member is formed by hydraulic spring with throttling in oil supply and/or one-way throttling in oil supply.

The centre of the combustion engine cylinder head is demountable from the body of the combustion engine cylinder head and/or valve guide for guiding the valve stems of ring-shaped valve are fitted with radial clearance in the centre and/or in the body of the combustion engine cylinder head.

The cylinder head of the combustion engine with ring-shaped valve achieves flow parameters, which are not achievable by any solution with classic lifting valves. It is thus possible to use it in new modern internal combustion engines. Thanks to concentric circular shape of the valve seats and valve plate with cylinder of the engine there is thermally uniform stress of all parts of the cylinder head. In arrangement, where outer valve seat is fixed and inner valve seat is axially movable, is the centre of the cylinder head less stressed than usual. Most of pressure force transfers the valve into the outer valve seat. Thanks to lower stress and simple shape there is no danger of cylinder head cracking even at high combustion pressure and temperature. Inner valve seat must have certain axial overlap T in order to ensure valve tightness. Size of this overlap is given by the stop position of seat movement towards cylinder, which is performed by e.g. safety ring. During installation is possible to set desired lift of movable seat, which is needed for safety and durable sealing of ring-shaped valve in closed position. Wear of seating face stops increase lift of slidably mounted seat. Wear of seating face for valve by this slidably fitted seat decreases adjusted overlap of slidably fitted seat. Wear of seating face between second fixed seat and valve increase overlap of movable seat. It is advantage that two wear factors increase adjusted overlap and one factor decreases it. It follows that for sufficient sealing will be the overlap permanent for a long period and won't need to be adjusted.

### BRIEF DESCRIPTION OF THE DRAWINGS

Cylinder head of the combustion engine with ring-shaped valve, according to the invention, will be described in more detail by individual examples shown on the attached drawings. On the FIG. 1 is sectional view of cylinder head of the combustion engine with ring-shaped valve, inner and outer valve seat. Outer valve seat is fixed in the cylinder head of the combustion engine and inner valve seat is mounted axially slidably. Inner valve seat is pressured to ring-shaped valve by coil springs by means of supporting pins, it is sealed against the centre of the combustion engine cylinder head by sealing ring and secured by safety ring. Seating face of the inner valve seat is spherical in shape.

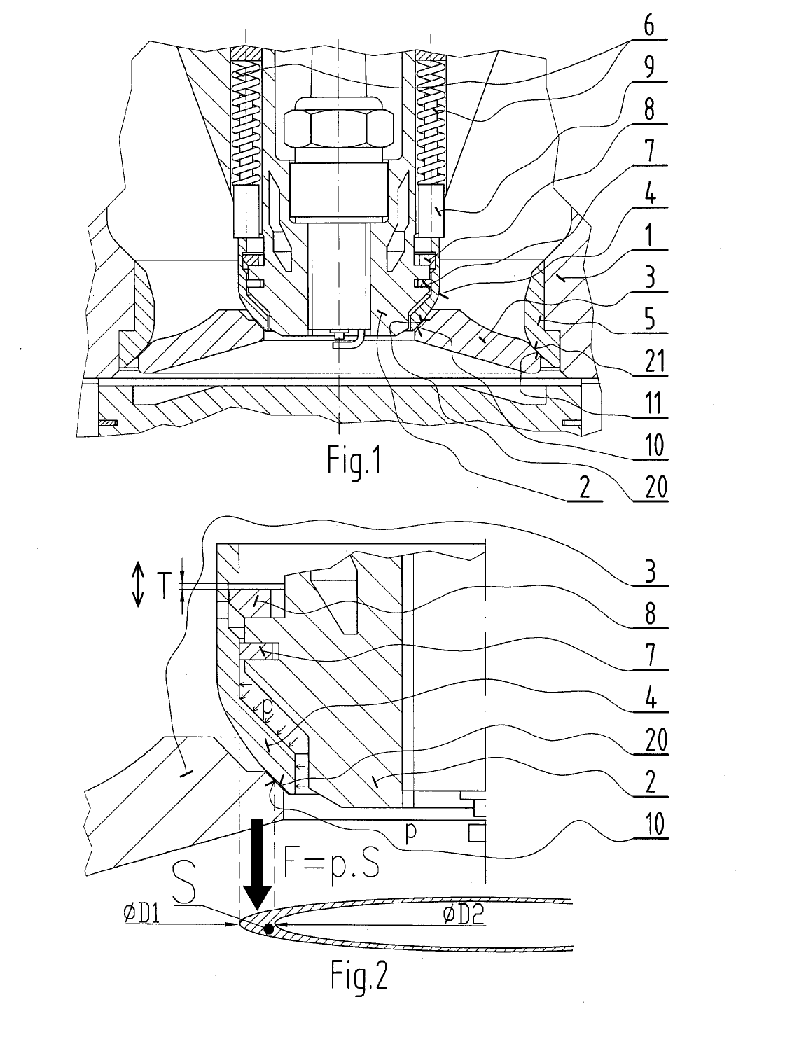

On the FIG. 2 is enlarged sectional view of inner valve seat placing from FIG. 1. Shown ring-shaped valve is in closed position and inner valve seat is therefore in pressured position. On the fig. is dimensioned lift of the inner valve seat T. Further is shown projection of surface S, on which acts pressure p and product of these quantities is pressure force F pushing inner valve seat to the ring-shaped valve.

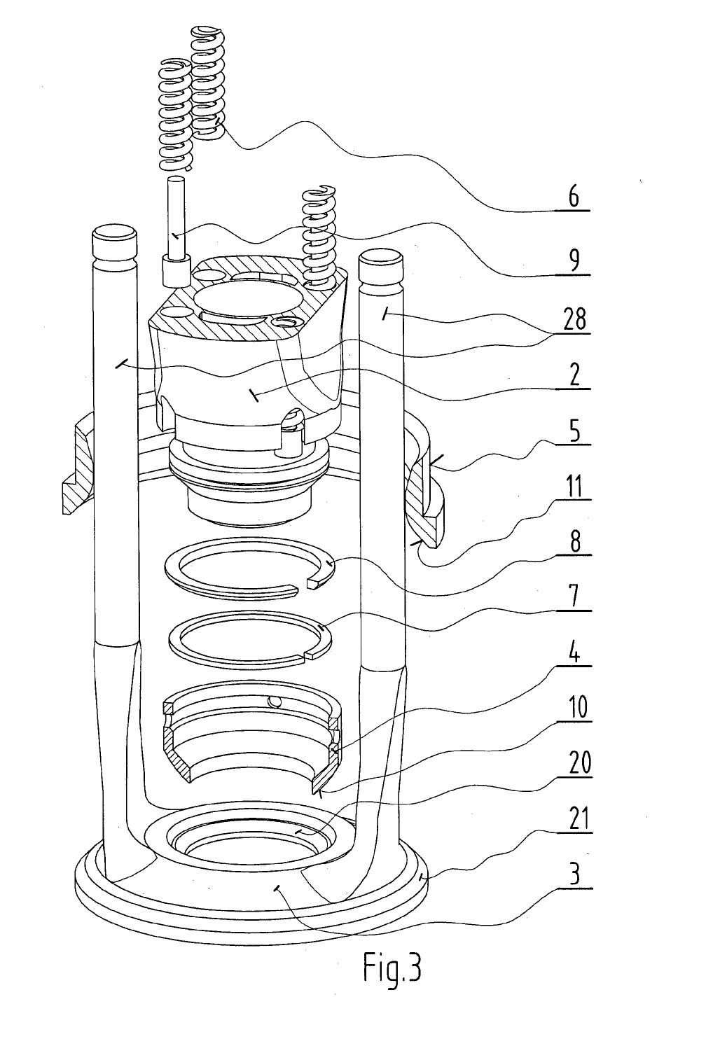

On the FIG. 3 is axonometric view of ring-shaped valve, both valve seats, centre of the cylinder head, rings, springs and pins, which were shown on FIG. 1.

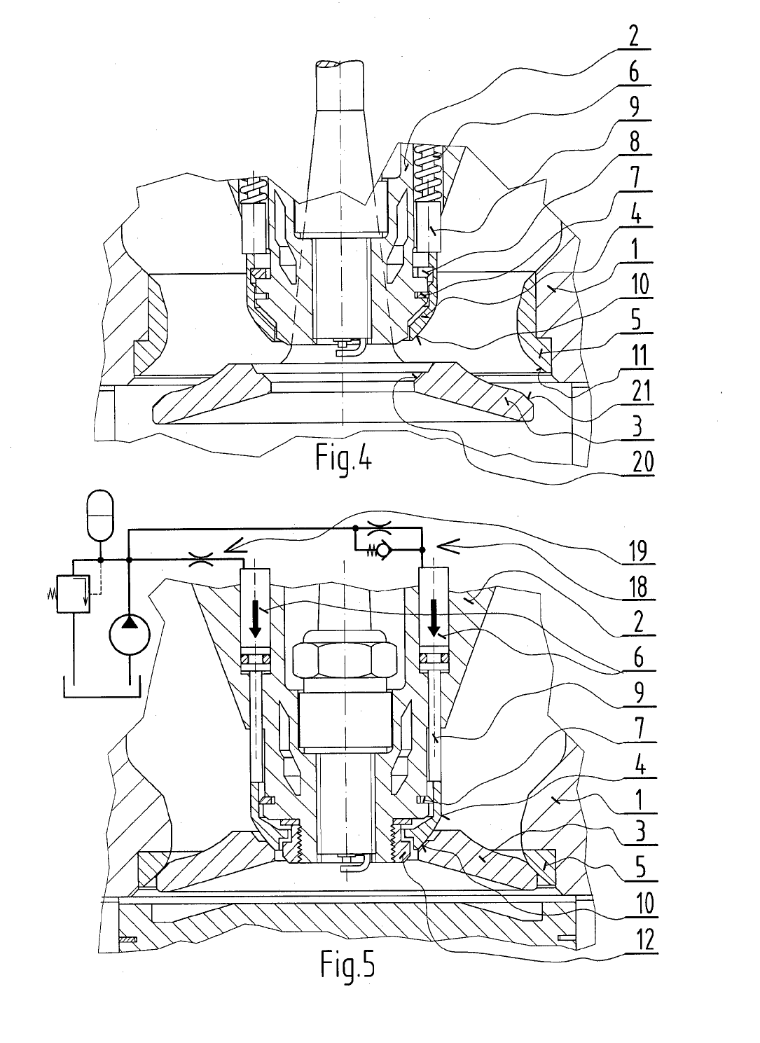

On the FIG. 4 is sectional view of the cylinder head from FIG. 1, but here is ring-shaped valve opened and inner valve seat is slid towards the cylinder.

On the FIG. 5 is sectional view of the cylinder head with ring-shaped valve similarly to FIG. 1. But inner valve seat is secured by thrust nut instead of safety ring. Sealing ring is with chamfer for improving the tightness and hydraulic cylinders with damping of move have function of pressure member.

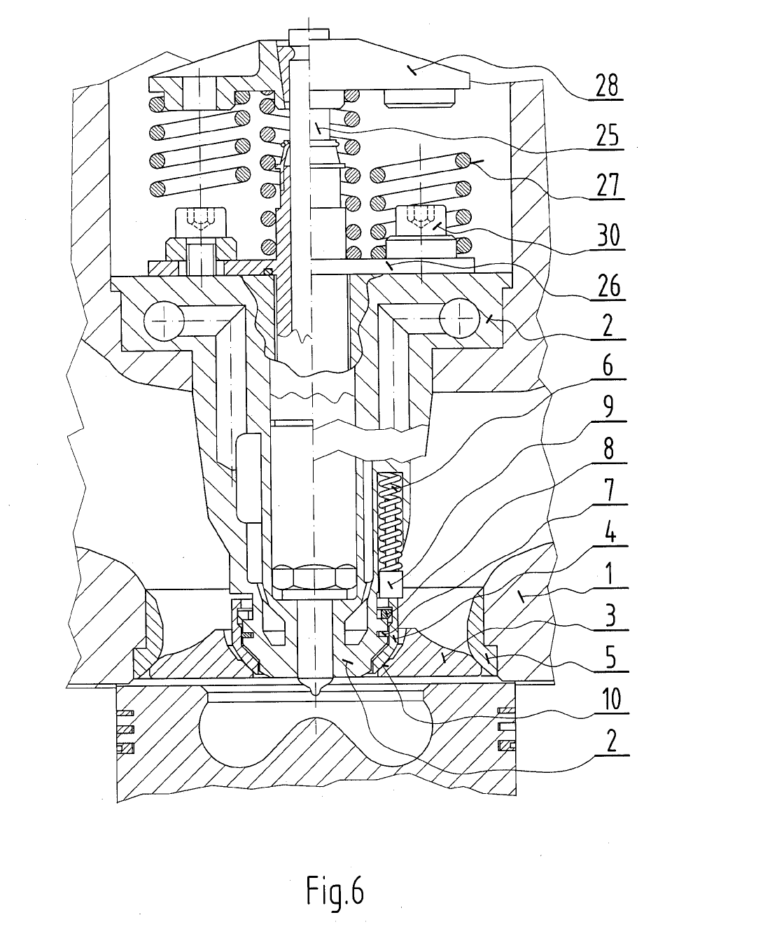

On the FIG. 6 is sectional view of the cylinder head with ring-shaped valve in design for compression ignition engine. On this figure is shown demountable centre of the cylinder head with supply of coolant, valve guide, valve springs etc. Inner valve seat and his placing is similar to FIG. 1.

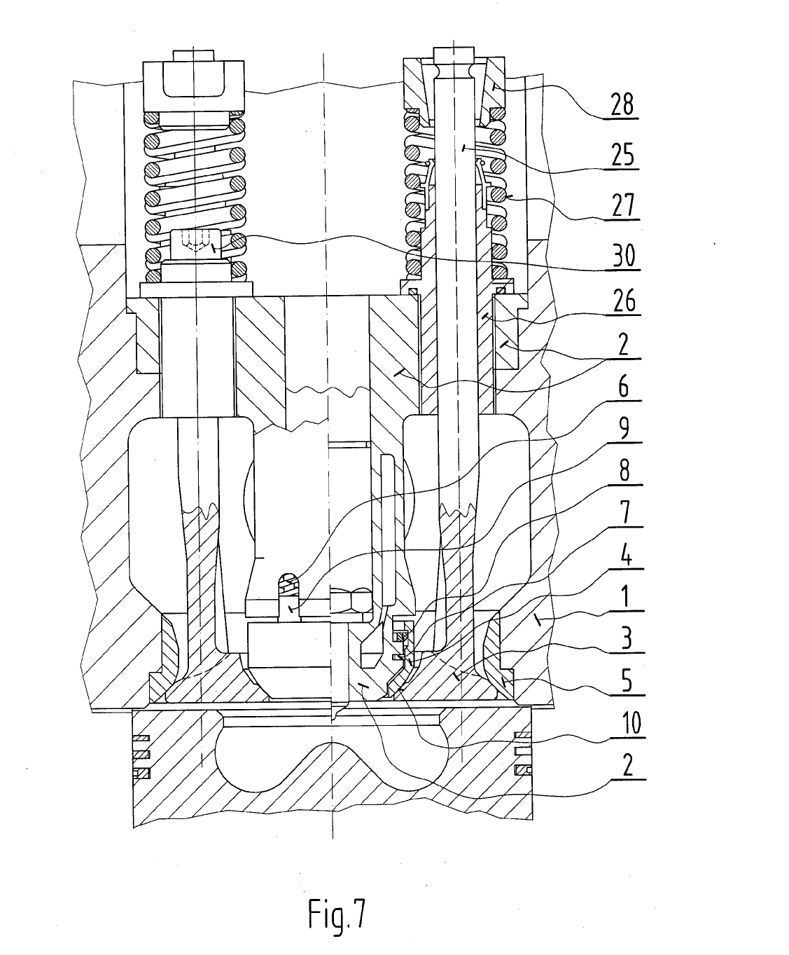

On the FIG. 7 is cross-sectional view of the cylinder head from FIG. 6.

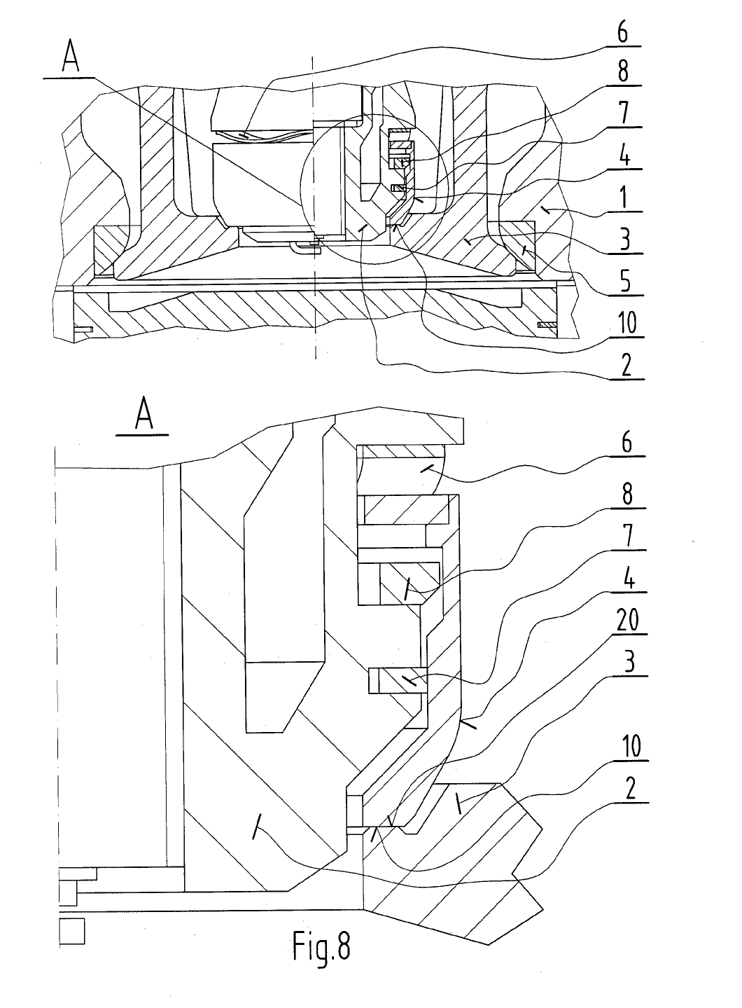

On the FIG. 8 is sectional view and detail of sectional view of the cylinder head with similar design to the FIG. 1. The difference is in use of spring made of corrugated iron instead of coil springs. Seating face of the valve seat is flat instead of spherical.

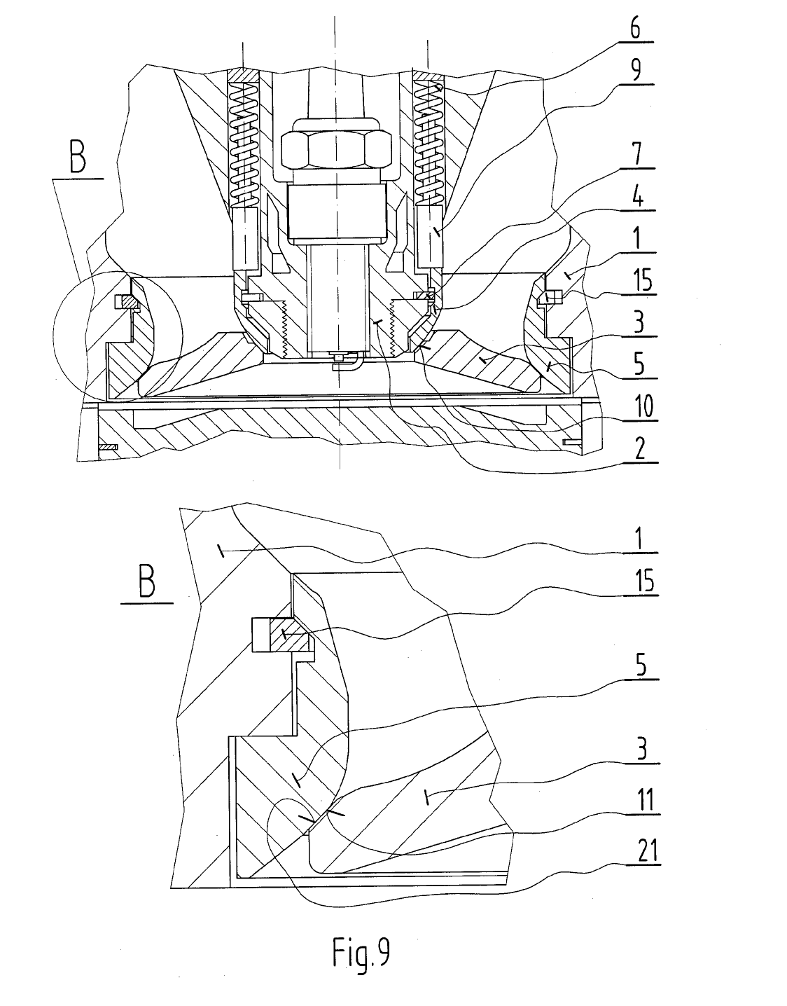

On the FIG. 9 is sectional view and detail of sectional view of the cylinder head with similar design to FIG. 1. The difference is in use of outer valve seat mounted with small radial clearance and secured against move by safety ring with chamfer. Next difference is that safety ring of axially movable inner valve seat is removed and his function has sealing ring.

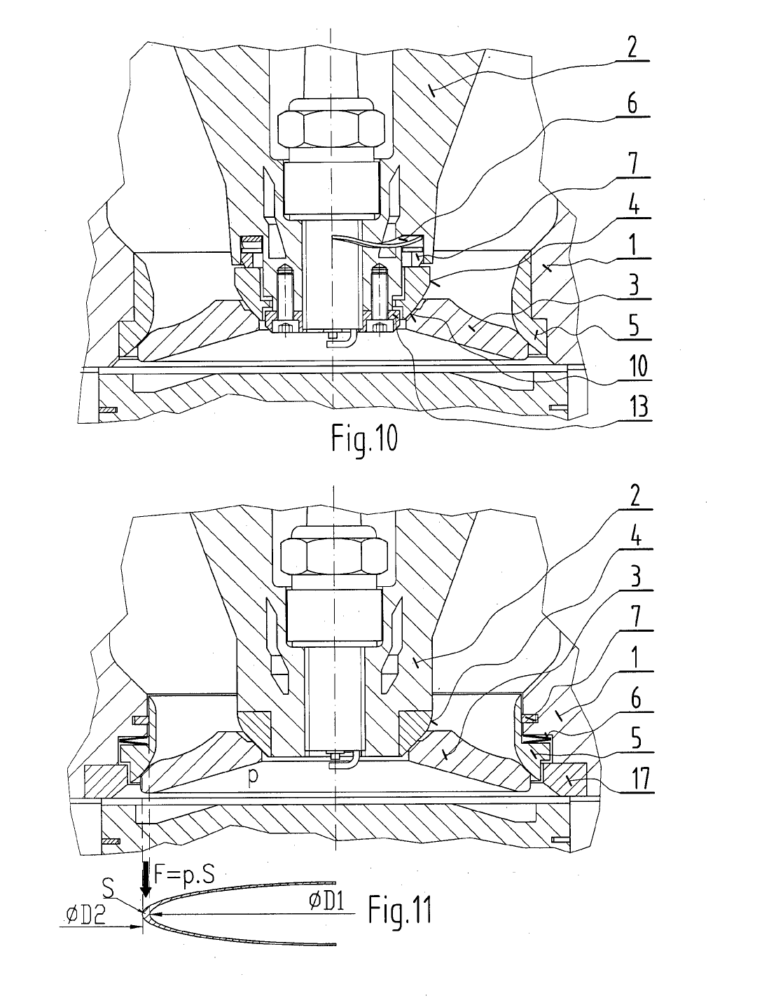

On the FIG. 10 is sectional view of the cylinder head with ring-shaped valve, inner and outer valve seat. Outer valve seat is fixed in the cylinder head and inner valve seat is mounted axially slidable. Inner valve seat is pushed against ring-shaped valve by spring made of corrugated iron. Between spring and valve seat is sealing ring, sitting down on the seat axially by its face. The stop limiting sliding of the seat is formed by circular plate fixed by bolts to the centre of the cylinder head.

On the FIG. 11 is sectional view of the cylinder head with ring-shaped valve, inner and outer valve seat. Outer valve seat is mounted axially slidably in the cylinder head and inner valve seat is fixed on the centre of the cylinder head. Outer valve seat is pushed against the ring-shaped valve by plate spring and is sealed by sealing ring against the cylinder head. The stop limiting sliding out of the seat is formed by circle annulus.

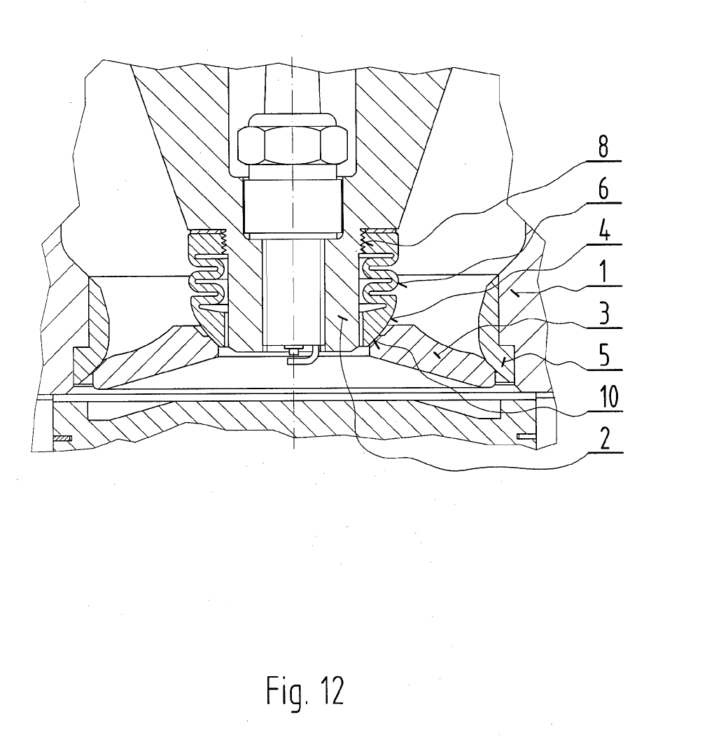

On the FIG. 12 is sectional view of the cylinder head with ring-shaped valve, inner and outer valve seat. Inner valve seat is created in the shape of bellows, which fulfils function of springy element. At the bottom of bellows is seating face for ring-shaped valve and at the top is secured by threaded connection preventing its pulling out towards the cylinder.

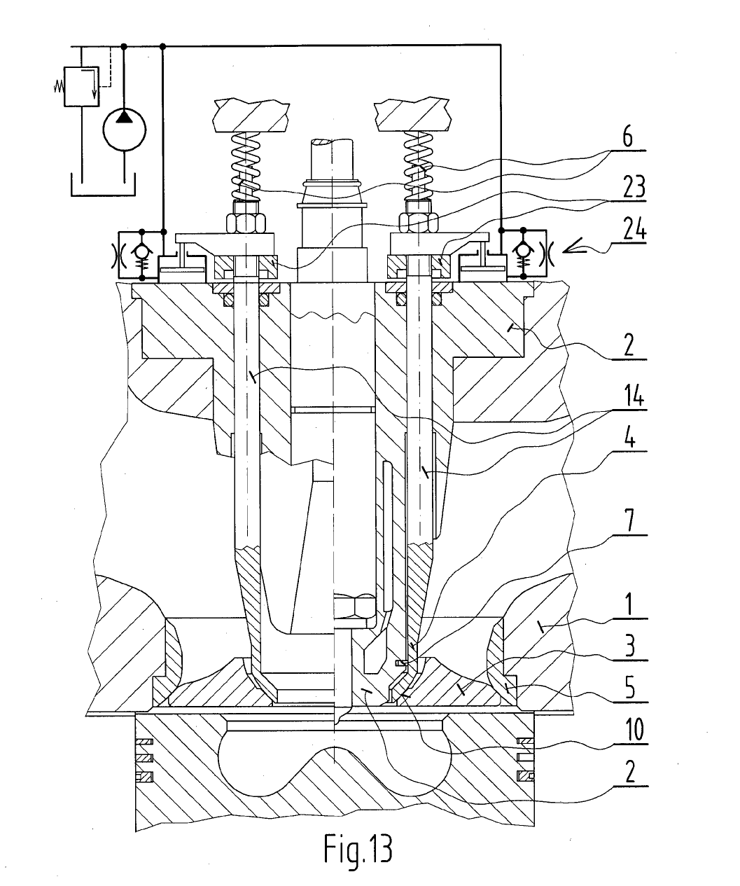

On the FIG. 13 is sectional view of the cylinder head with ring-shaped valve, inner and outer valve seat. Outer valve seat is fixed in the cylinder head and inner valve seat is fitted axially slidable. It is sealed against the centre of the cylinder head by the sealing ring. Inner valve seat has two stems leading to the top of the cylinder head. On the stems are adjustable stops limiting sliding out of the seat. The stems are acted by hydraulic movement damper of inner valve seat.

### DETAILED DESCRIPTION OF THE PREFERRED EMBODIMENTS

The model cylinder head of a combustion engine with ring-shaped valve according to FIG. 1, FIG. 2, FIG. 3 and FIG. 4 is formed by body 1 and rigid centre 2 of the cylinder head. In the cylinder head is situated lifting ring-shaped valve 3 with conical outer seating face 21 and conical inner seating face 20. This ring-shaped valve 3 in its closed position sits down into outer valve seat 5, which is rigidly fastened in body 1, and inner valve seat 4, which is fitted axially slideably in the centre 2 of a cylinder head of combustion engine. Seating face 11 of outer valve seat 5 is conical and seating face 10 of inner valve seat 4 is spherical. On the inner valve seat 4 sit down pins 9 with pressure elements 6 in the shape of spring. Inner valve seat 4 is sealed by sealing member 7 ring, placed in a groove in rigid centre 2 and secured by safety member 8, in this case by ring.

Embodiment of a cylinder head of an internal combustion engine with ring-shaped valve 3 according to FIG. 5 is based on the embodiment according to FIG. 1. As a pressure member 6 is used hydraulic spring with damping by throttling 19 or by one-way throttling 18 in oil supply. Securing of lift of axially slidable seat 4 is performed by safety member in the shape of thrust nut 12 mounted on the centre 2 of head. For sealing is used sealing member 7 in the shape of ring with chamfer.

Embodiment of a cylinder head of an internal combustion engine with ring-shaped valve 3 according to FIG. 6 and FIG. 7 is based on the embodiment according to FIG. 1. Ring-shaped valve 3 has a flat shape suitable for diesel engine. Rigid centre 2 is demountable from body 1 of a head. Two valve stems 25 of the ring-shaped valve 3 are guided in two guides 26, which are in center 2 and body 1 of a cylinder head mounted with radial clearance. They are fastened by bolts 30. Two triad of valve springs 27 are based on two clamps 28 fixed to two stems 25 of ring-shaped valve 3.

In embodiment of a cylinder head of an internal combustion engine with ring-shaped valve 3 according to FIG. 8 is seating face 10 of axially slidable inner valve seat 4 of planar shape. Likewise, the seating face 20 on the ring-shaped valve 3 is planar in shape. Springing of the inner valve seat 4 is performed by pressure element 6 in a shape of spring made of corrugated iron.

In embodiment of a cylinder head of an internal combustion engine with ring-shaped valve 3 according to FIG. 9 is axially slidably fitted inner valve seat 4. Sealing member 7 in the shape of ring is at the same time axial fastening of the inner valve seat 4 preventing its pulling towards the cylinder. Another safety member is not used. Outer valve seat 5, which is not axially movable, is in the body 1 of a head fitted with small radial clearance. Against axial movement and pulling out is secured by safety ring 15. Radial clearance of outer valve seat 5 enables keeping ideal circularity of the seating face 11.

In embodiment of a cylinder head of an internal combustion engine with ring-shaped valve 3 according to FIG. 10 is axially slidably fitted inner valve seat 4. On it sits down frontally sealing member 7 ring, which is placed in frontal groove in the rigid centre 2. On second frontal surface of sealing member 7 ring, sits down pressure member 6 spring, made of corrugated iron. Securing of the lift of axially slidable seat 4 is performed by safety member, in this case by plate 13 fixed on the rigid centre 2 by bolts.

In embodiment of a cylinder head of an internal combustion engine with ring-shaped valve 3 according to FIG. 11 is axially slidably fitted outer valve seat 5 and inner valve seat 4 is fixed in the centre 2 of a head. In a groove in the body 1 of a head is placed sealing member 7 ring, which fits on outer valve seat 5. Springing of the outer valve seat 5 is performed by pressure element 6 in the shape of a plate spring. Securing of the outer valve seat 5 is performed by safety ring in the shape of annulus 17, which is placed in the body 1.

In embodiment of a cylinder head of an internal combustion engine with ring-shaped valve 3 according to FIG. 12 is axially slidable inner valve seat 4 performed in a shape of bellows. The middle part fulfils function of pressure member 6. At the bottom is seating face 10 and at the top is bellows secured by safety member 8 threaded connection preventing its pulling towards cylinder. Advantage is in absence of sealing member 7. But there will be high demands on material of a bellows, which will be cyclically stressed by pressing by valve 3, combustion pressures in a cylinder and changing of temperatures.

In embodiment of a cylinder head of an internal combustion engine with ring-shaped valve 3 according to FIG. 13 is outer valve seat 5 fixed in the body 1. Axially slidably fitted inner valve seat 4 is sealed by sealing member 7 ring, which is placed in a groove in the rigid centre 2. Inner valve seat 4 is provided with two stems 14, which lead through the rigid centre 2. On the ends of stems 14 there are fastened stops 23 of axial lift of inner valve seat 4. On the ends of stems 14 sit down pressure members 6 in the shape of spring and hydraulic dampers 24 are connected to them. Seating face 10 of the inner valve seat 4 is conical.

At a cylinder head of an internal combustion engine with ring-shaped valve 3 is function following. Ring-shaped valve 3 by closing sits down at first on the axially slidably fitted usually inner valve seat 4, compress this inner valve seat 4 against the resistance of pressure member 6 to lift T and then sits down into rigid, usually outer valve seat 5. Seating face 10 of inner valve seat 4 may be advantageously spherical and then is secured perfect tightness of this inner valve seat 4 in the seating face 20 of ring-shaped valve 3 even in case of modest turning of inner valve seat 4. This seating face 20 may be conical or spherical as well. Increase of pressure in a cylinder of engine causes pushing the axial slidably fitted inner valve seat 4 to ring-shaped valve 3 by pressure force F. It is caused by suitable shape of inner valve seat 4, where diameter D1 of contact with sealing member 7-ring, is greater than diameter D2 of contact of seating faces 10 and 20. Tightness between centre 2 of a head and axially slidably fitted inner valve seat 4 secures sealing member 7-ring, which is advantageously placed in a groove in the centre 2 of head. Next process of cylinder head of an internal combustion engine causes opening the ring-shaped valve 3. If there is higher pressure in cylinder before opening than pressure above ring-shaped valve 3, axially slidably fitted inner valve seat 4 will be able to be pushed to the ring-shaped valve 3 by pressure force F even during valve 3 opening in addition to force of pressure member 6. It will be thus pulled towards cylinder until movement of seat is stopped by safety member 8. By this cyclical motion of inner seat 4 will be removed 25″ sediment from interstice between inner valve seat 4 and centre 2 of head. This requires that the radial clearance between inner valve seat 4 and the centre 2 of head was sufficient and then will not threaten getting stuck of inner valve seat 4. Inner valve seat 4 is after opening valve 3 ready in extended position. Required overlap T, which is necessary for keeping tightness of ring-shaped valve 3 while engine is running, is influenced by wear of valve gear component. This overlap T is decreased by wear of seating faces 10 and 20. By wear of seating faces 11 and 21 is increased and by wear of safety member 8 is increased too. Keeping the overlap T seems to be sustainable. In case of using hydraulic cylinder as the pressure member 6 is possible to absorb the move of inner valve seat 4 by throttling 19 in both directions or by one-way damping 18 in oil supply. Similar function of a cylinder head with ring-shaped valve 3 is even in case of use inner valve seat 4 with stems 14, which ends are provided with pressure members 6 and stops 23 substituting safety member 8. Hydraulic damper 24 decreases lift of the inner valve seat 4 and thus its wear too while engine is running.

Similar function of a head will be even in case when axially slidable will be outer valve seat 5. In closed position of ring-shaped valve 3 will pressure force F pressure the axially slidable outer valve seat 5 to ring-shaped valve 3 only when diameter D1 of contact with sealing member 7 ring, will be smaller than diameter D2 of contact of seating faces 11 and 21.

As the pressure member 6 can be used spring of various types. Also it may be hydraulic or pneumatic cylinder, electromagnet and the like.

Function of safety member 8 can fulfill even thrust nut 12 or plate 13 fixed in the centre 2 of head. Safety member can be annulus 17 or it can be generally formed by stops from bolts, pins and the like.

For assembling and adjustment of the inner valve seat 4 is advantageous, when centre 2 of head is demountable. For assembling of ring-shaped valve 3 is advantageous, when the valve guides 26 are fitted with radial clearance. Their position can be secured according to the position of ring-shaped valve 3 and its stems 25.

### INDUSTRIAL APPLICABILITY

A head of an internal combustion engine with ring-shaped valve according to this invention will find use in various types of internal combustion engines for controlling intake, exhaust or common function of intake and exhaust. Use for example for exhaust at two-stroke engine or at four-stroke engine common for both exhaust and intake.

1. A cylinder head with ring-shaped valve for internal combustion engine comprising the body and rigid center of the cylinder head and ring-shaped valve with outer seating face and inner seating face, which in closed position sits down into the outer valve seat err with outer seating face and inner valve seat with inner seating face, wherein the inner valve seat or outer valve seat is fitted slidably in axial direction and at least one pressure member is connected to inner valve seat or to outer valve seat for causing force against the ring-shaped valve.

2. The cylinder head according to claim 1, wherein the slidably movable inner valve seat or outer valve seat is provided with at least one sealing member, which is situated between inner valve seat and the center of combustion engine cylinder head a or between outer valve seat and the body of combustion engine cylinder head.

3. The cylinder head according to claim 2, wherein the sealing member is placed in a groove in the center of combustion engine cylinder head or in the body of combustion engine cylinder head.

4. The cylinder head according to claim 3, wherein sealing member is provided with sealing ring on the slidably movable inner valve seat, where the diameter of contact of sealing member with inner valve seat is greater than the diameter of seating face of this inner valve seat with ring-shaped valve.

5. The cylinder head according to claim 3, wherein the sealing member is provided with sealing ring on the slidably movable outer valve seat, where the diameter of contact of sealing ring with outer valve seat is smaller than the diameter of seating face of this outer valve seat with ring-shaped valve.

6. The cylinder head according to claim 1, wherein the slidably moveable inner valve seat or outer valve seat is provided with safety member preventing its pulling toward cylinder.

7. The cylinder head according to claim 1, wherein the slidable movable inner valve seat or outer valve seat is provided with at least two stems, leading through the center or through the body of combustion engine cylinder head, provided with adjustable stops or dampers on their ends.

8. The cylinder head according to claim 1, wherein the seating face of slidably movable inner valve seat or outer valve seat is spherical.

9. The cylinder head according to claim 1, wherein the pressure member is provided with hydraulic spring with throttling in oil supply or one-way throttling in oil supply.

10. The cylinder head according to claim 1, wherein the center of combustion engine cylinder head is demountable from body of combustion engine cylinder head or valve guides for guiding the valve stems of ring-shaped valve are fitted with radial clearance in the center or in the body of combustion engine cylinder head.
